(19) United States
(12) Patent Application Publication
(10) Pub. No.: US 2024/0113291 A1
(43) Pub. Date: Apr. 4, 2024

(54) NEGATIVE ELECTRODE ACTIVE MATERIAL COMPOSITION, AND ALL-SOLID-STATE SECONDARY BATTERY INCLUDING SAME

(71) Applicant: UBE Corporation, Ube-shi (JP)

(72) Inventors: Kei SHIMAMOTO, Ube-shi (JP); Shinichirou OOTANI, Ube-shi (JP); Takumi TAKENAKA, Sakai-shi (JP)

(73) Assignee: UBE Corporation, Ube-shi (JP)

(21) Appl. No.: 18/263,916

(22) PCT Filed: Feb. 3, 2022
(86) PCT No.: PCT/JP2022/004326

§ 371 Date: Aug. 2, 2023

(30) Foreign Application Priority Data
Feb. 3, 2021 (JP) 2021-015923
Oct. 29, 2021 (JP) 2021-177612

(51) Int. Cl. H01M 4/485; H01M 10/052; H01M 10/0562

(52) U.S. Cl. CPC H01M 4/485; H01M 10/052; H01M 10/0562; H01M 2004/027

(57) ABSTRACT

Provided is a negative electrode active material composition including a lithium titanate powder whose main component is Li₄Ti₅O₁₂ and an inorganic solid electrolyte having conductivity for metal ions belonging to Group 1 of Periodic Table, wherein at least one metal element selected from the group consisting of Al, W, Ce, and Mo is present on the surfaces of lithium titanate particles constituting the lithium titanate powder.

### TECHNICAL FIELD

The present invention relates to a negative electrode active material composition using a lithium titanate powder suitable as a negative electrode material for an all-solid-state secondary battery and relates also to an all-solid-state secondary battery.

### BACKGROUND ART

In recent years, power storage devices, especially lithium batteries, have been widely used for small electronic devices such as mobile phones and laptop computers and electric vehicles and for power storage applications. In the present specification, the term lithium battery is used as a concept that encompasses so-called lithium ion secondary batteries.

Currently commercially available lithium batteries are mainly composed of positive and negative electrodes that contain materials capable of absorbing and desorbing lithium, and a non-aqueous electrolytic solution that contains a lithium salt and a non-aqueous solvent. Examples of the non-aqueous solvent for use include cyclic carbonates such as ethylene carbonate (EC) and propylene carbonate (PC) and chain carbonates such as dimethyl carbonate (DMC) and diethyl carbonate (DEC). Lithium batteries use an electrolytic solution that contains such a flammable organic solvent and are therefore prone to liquid leakage and may ignite when short-circuited, and it is thus necessary to install a safety device to suppress the temperature rise during short-circuiting and a structure to prevent short-circuiting.

Under such circumstances, all-solid-state secondary batteries using an inorganic solid electrolyte instead of organic electrolytic solution are attracting attention. Since the positive electrode, negative electrode, and electrolyte of all-solid-state secondary batteries are all solid, they have the potential to remarkably improve the safety and reliability, which are the challenges for batteries using an organic electrolytic solution, and also to simplify the safety device, thus enabling high energy density, and the all-solid-state secondary batteries are therefore expected to be applied to electric vehicles, large storage batteries, etc.

Unlike conventional lithium-ion secondary batteries that use an electrolytic solution, in all-solid-state secondary batteries, it is very important to form a good solid-solid interface and continuously maintain the interface from the viewpoint of achieving excellent ion conductivity and long-term cycle characteristics. Lithium titanate attracts attention for maintaining a good interface between the active material and the solid electrolyte. Lithium titanate is expected to maintain the interface between the active material and the solid electrolyte for a long period of time during charge/discharge because the volume change due to charge/discharge is very small. Patent Document 1 discloses an electrode that uses lithium titanate having a certain BET specific surface area and solid electrolyte particles smaller than the average particle diameter of the lithium titanate and reports that the contact between the lithium titanate and the solid electrolyte particles becomes better than prior art. Patent Document 2 discloses a lithium titanate powder having a specific surface area of 4 m²/g or greater and containing at least one localization element selected from among boron (B), Ln (Ln is at least one metal element selected from among lanthanoid element group, Y, and Sc), and M1 (M1 is at least one metal element selected from among W and Mo), wherein the boron (B), Ln, and M1 as the localization elements exist localized in the vicinity of the surfaces of lithium titanate particles constituting the lithium titanate powder. Patent Document 2 also discloses a lithium titanate powder that, when applied as an electrode material for an electricity storage device, has a large charge/discharge capacity and can suppress the amount of gas generated during high-temperature operation.

### PRIOR ART DOCUMENTS

### Patent Documents

Patent Document 1: JP2012-243644A
Patent Document 2: WO2018/110708

### SUMMARY OF INVENTION

### Problems to be Solved by Invention

By using the electrode of Patent Document 1, the contact between the lithium titanate powder and the solid electrolyte powder seems to become good to improve the battery characteristics of the all-solid-state secondary battery, but further improvement may be necessary. In particular, when lithium titanate particles having a relatively small average particle diameter are used, deterioration in battery characteristics is observed even in the configuration of Patent Document 1. This appears to be because the lithium titanate particles agglomerate together and satisfactory contact between the lithium titanate powder and the solid electrolyte powder can not be obtained. To solve the above problems, the present invention provides a negative electrode active material composition that can form a good solid-solid interface with a solid electrolyte regardless of the particle diameter of the lithium titanate powder and that can also form a dense negative electrode layer having fewer voids than conventional ones, and an all-solid-state secondary battery.

### Means for Solving Problems

As a result of intensive researches to further increase the contact areas between lithium titanate particles and solid electrolyte even when lithium titanate powder having a relatively small average particle diameter is used, the present inventors have found that by allowing a specific metal element to exist on the surfaces of primary particles of lithium titanate powder, the lithium titanate powder and the solid electrolyte form good solid-solid interfaces and a dense negative electrode layer having fewer voids than conventional ones can be obtained, and have thus accomplished the present invention. By using the negative electrode active material composition including the lithium titanate powder and the solid electrolyte in an all-solid-state secondary battery, it is possible to increase the initial discharge capacity and improve the charge rate characteristics. It should be noted that nothing in Patent Document 2 describes or suggests an effect of increasing the density of a negative electrode layer containing a negative electrode active material and a solid electrolyte in an all-solid-state secondary battery.

The present invention relates to a negative electrode active material composition using a lithium titanate powder suitable as a negative electrode material for an all-solid-state secondary battery and relates also to an all-solid-state secondary battery.

That is, the present invention provides the following (1) to (9).
(1) A negative electrode active material composition comprising: a lithium titanate powder whose main component is Li₄Ti₅O₁₂; and an inorganic solid electrolyte having conductivity for metal ions belonging to Group 1 of Periodic Table, wherein at least one metal element selected from the group consisting of Al, W, Ce, and Mo is present on surfaces of lithium titanate particles constituting the lithium titanate powder.
(2) The negative electrode active material composition according to (1), wherein the inorganic solid electrolyte is a sulfide solid electrolyte.
(3) The negative electrode active material composition according to (1) or (2), wherein the content ratio of the metal element in the lithium titanate powder is 0.01 mass % or more and 5 mass % or less.
(4) The negative electrode active material composition according to any one of (1) to (3), wherein two or more of the metal elements are present on the surfaces of the lithium titanate particles.
(5) The negative electrode active material composition according to any one of (1) to (4), wherein D50 of primary particles corresponding to a volume accumulation of 50% in a volume-based particle size distribution of the lithium titanate powder is 0.5 μm or more, wherein the volume-based particle size distribution is measured by a laser diffraction scattering method.
(6) The negative electrode active material composition according to any one of (1) to (5), wherein D50 of primary particles corresponding to a volume accumulation of 50% in a volume-based particle size distribution of the lithium titanate powder is 2.5 μm or less, wherein the volume-based particle size distribution is measured by a laser diffraction scattering method.
(7) The negative electrode active material composition according to any one of (1) to (6), wherein the content of the inorganic solid electrolyte is 1 mass % or more and 50 mass % or less in the negative electrode active material composition.
(8) The negative electrode active material composition according to any one of (1) to (7), wherein a relation represented by the following expression (I) is satisfied:

C1>C2 (I)

where C1 (atm %) is a total metal element concentration at an inner position of 1 nm from surfaces of primary particles of the lithium titanate, the inner position being located on a straight line that extends from the surface of each primary particle of lithium titanate and is drawn orthogonal to a tangent of the surface of the primary particle of lithium titanate, and C2 (atm %) is the total metal element concentration at a depth position of 100 nm from the surfaces of the primary particles of the lithium titanate, the depth position being located on a straight line that extends from the surface of each primary particle of lithium titanate and is drawn orthogonal to a tangent of the surface of the primary particle of lithium titanate, the total metal element concentration being measured by energy dispersive X-ray spectroscopy in cross-sectional analysis of the primary particles of lithium titanate constituting the lithium titanate powder using a scanning transmission electron microscope.
(9) An all-solid-state secondary battery comprising a positive electrode layer, a negative electrode layer, and a solid electrolyte layer, wherein the negative electrode layer is a layer containing the negative electrode active material composition according to any one of the above (1) to (8).

### Effects of Invention

According to the present invention, by forming good solid-solid interfaces with the solid electrolyte regardless of the particle diameter of the lithium titanate powder, and further by forming a dense negative electrode layer having fewer voids than conventional ones, it is possible to obtain a negative electrode active material composition and an all-solid-state secondary battery that are excellent in the initial discharge capacity, initial efficiency, and charge rate characteristics.

### MODES FOR CARRYING OUT THE INVENTION

The present invention relates to a negative electrode active material composition using a lithium titanate powder suitable as a negative electrode material for an all-solid-state secondary battery and relates also to an all-solid-state secondary battery.

### «Negative Electrode Active Material Composition»

The negative electrode active material composition of the present invention is a negative electrode active material composition comprising: a lithium titanate powder whose main component is Li₄Ti₅O₁₂; and an inorganic solid electrolyte having conductivity for metal ions belonging to Group 1 of Periodic Table,

wherein one or more metal elements selected from Al, W, Ce, and Mo are present on the surfaces of lithium titanate particles constituting the lithium titanate powder.

«Lithium Titanate Powder Whose Main Component is Li₄Ti₅O₁₂»

The lithium titanate powder of the present invention contains Li₄Ti₅O₁₂ as a main component and can contain a crystalline component and/or an amorphous component other than Li₄Ti₅O₁₂ within a range in which the effects of the present invention can be obtained. The main component as used herein refers to the proportion of the intensity of the Li₄Ti₅O₁₂ main peak being 90% or more of the diffraction peaks measured by X-ray diffraction. In the lithium titanate powder of the present invention, the proportion of the intensity of the Li₄Ti₅O₁₂ main peak is preferably 92% or more and more preferably 95% or more of the diffraction peaks measured by the X-ray diffraction. Components other than Li₄Ti₅O₁₂ refer to the sum of the intensity of the main peak attributed to crystalline components and the highest intensity of the halo pattern attributed to amorphous components. In particular, the lithium titanate powder of the present invention may contain, as the crystalline components, anatase titanium dioxide, rutile titanium dioxide, and lithium titanate having a different formula, such as Li₂TiO₃ or Li_{0.6}TiO_{3.4}O₈. The lithium titanate powder of the present invention can improve the charge characteristics and charge/discharge capacity of an electricity storage device as the occurrence proportion of crystalline components other than Li₄Ti₅O₁₂, particularly Li_{0.6}Ti_{3.4}O₈, decreases. It is particularly preferred that the sum of the intensity of the main peak of anatase titanium dioxide, the intensity of the main peak of rutile titanium dioxide, and the intensity corresponding to the main peak of Li₂TiO₃ (which is calculated by multiplying the peak intensity corresponding to the (−133) plane of Li₂TiO₃ by 100/80) be 5 or less, where the intensity of the main peak of Li₄Ti₅O₁₂ among the diffraction peaks measured by X-ray diffraction is 100. Here, the main peak of Li₄Ti₅O₁₂ refers to a peak corresponding to the diffraction peak attributed to the (111) plane (20=18.33) of Li₄Ti₅O₁₂ in the PDF card 00-049-0207 of ICDD (PDF 2010). The main peak of anatase titanium dioxide refers to a peak corresponding to the diffraction peak attributed to the (101) plane (2θ=25.42) in the PDF card 01-070-6826. The main peak of rutile titanium dioxide refers to a peak corresponding to the diffraction peak attributed to the (110) plane (2θ=27.44) in the PDF card 01-070-7347. The peak corresponding to the (−133) plane of Li₂TiO₃ refers to a peak corresponding to the diffraction peak attributed to the (−133) plane (2θ=43.58) of Li₂TiO₃ in the PDF card 00-033-0831. The main peak of Li_{0.6}Ti_{3.4}O₈ refers to a peak corresponding to the diffraction peak attributed to the (101) plane (2θ=19.98) in the PDF card 01-070-2732. The term “ICDD” is an abbreviation of International Centre for Diffraction Data, and “PDF” is an abbreviation of the powder diffraction file.

### <Containment of Metal Elements>

The lithium titanate powder of the present invention contains one or more metal elements selected from Al, W, Ce, and Mo on the surfaces of lithium titanate particles constituting the lithium titanate powder. Containing the one or more metal elements means that one or more of Al, W, Ce, and Mo are detected by a known analysis device such as X-ray fluorescence spectrometry (XRF) or inductively coupled plasma atomic emission spectrometry (ICP-AES) for the lithium titanate powder of the present invention. The lower limit of the quantity detectable by the inductively coupled plasma atomic emission spectrometry is usually 0.001 mass %.

### <Content Ratio of Metal Elements>

The content ratio of the one or more metal elements selected from Al, W, Ce, and Mo in the lithium titanate powder of the present invention determined by X-ray fluorescence analysis (XRF) is 0.01 mass % or more and 5 mass % or less as the total content of one or more of Al, W, Ce, and Mo. When the content ratio of the metal element is within this range, a dense negative electrode layer having few voids can be obtained, and an all-solid-state secondary battery excellent in the initial discharge capacity, initial efficiency, and charge rate characteristics can be obtained. The content ratio of the one or more metal elements selected from Al, W, Ce, and Mo is preferably 0.01 mass % or more and 2 mass % or less, more preferably 0.01 mass % or more and 1.2 mass % or less, further preferably 0.01 mass % or more and 0.8 mass % or less, furthermore preferably 0.1 mass % or more and 0.6 mass % or less, and particularly preferably 0.1 mass % or more and 0.4 mass % or less. The content ratio represents a ratio of the mass of the metal elements to the mass of the entire lithium titanate powder.

In the lithium titanate powder of the present invention, it is sufficient that one or more metal elements selected from Al, W, Ce, and Mo are present on the surfaces of the lithium titanate particles constituting the lithium titanate powder, and it is preferred that the one or more metal elements selected from Al, W, Ce, and Mo be present more on the surfaces of primary particles of lithium titanate contained in the lithium titanate powder than inside the primary particles. Specifically, the relation represented by the following expression (I) is preferably satisfied, and the relation represented by the following expression (II) is more preferably satisfied:

C1>C2 (I)

C1/C2≥5 (II)

where C1 (atm %) is the atomic concentration of the metal elements at a depth position of 1 nm from the surfaces of primary particles of the lithium titanate, and C2 (atm %) is the atomic concentration of the metal elements at a depth position of 100 nm from the surfaces of primary particles of the lithium titanate. The atomic concentrations are measured by energy dispersive X-ray spectroscopy in cross-sectional analysis of the primary particles of the lithium titanate using a scanning transmission electron microscope.

In the lithium titanate powder of the present invention, preferably, the metal elements are not detected at a depth position of 100 nm from the surfaces of the primary particles of the lithium titanate measured by energy dispersive X-ray spectroscopy using a scanning transmission electron microscope in cross-sectional analysis of the primary particles of the lithium titanate constituting the lithium titanate powder. It is preferred that the metal elements be fixed on the surfaces of the primary particles in a chemically bonded state. When the metal elements are present in such a state, a dense negative electrode layer having few voids can be obtained, and an all-solid-state secondary battery excellent in the initial discharge capacity, initial efficiency, and charge rate characteristics can be obtained. Although the lower limit of the quantity detectable by energy dispersive X-ray spectroscopy varies according to the elements to be measured or the state thereof, the lower limit is usually 0.5 atm %. The metal elements may therefore be detected in a range of 0.5 atm % or less at a depth position of about 100 nm.

The lithium titanate powder of the present invention may contain one or more metal elements selected from Al, W, Ce, and Mo, preferably contains one or more metal elements selected from Al, Ce, and Mo, more preferably contains one or more metal elements selected from Al and Mo, and further preferably contains Al. The lithium titanate powder of the present invention, which may contain two or more of the metal elements, contains one or more of these metal elements, and can thereby enhance the initial discharge capacity, initial efficiency, and charge rate characteristics. Examples of a suitable combination of the metal elements include a combination of Al and Mo, and the ratio of Al:Mo (mass ratio) is preferably 20:80 to 70:30.

### <D50>

D50 of the lithium titanate powder of the present invention is an index of the volume median particle diameter. It means a particle diameter at which the cumulative volume frequency calculated based on the volume fraction is 50% in cumulation in ascending order of particle diameter. The cumulative volume frequency is obtained by laser diffraction/scattering particle size distribution measurement. The measuring method will be described in Examples, which will be described later.

From the viewpoint of improving the initial discharge capacity and charge rate characteristic and the density of the negative electrode layer, D50 of the primary particles of the lithium titanate powder according to the present invention is 0.5 μm or more, preferably 0.55 μm or more, and more preferably 0.6 μm or more. Additionally or alternatively, D50 of the primary particles is 5 μm or less, preferably 4 μm or less, more preferably 2.5 μm or less, further preferably 2 μm or less, and particularly preferably 1.8 μm or less. The lithium titanate powder may contain primary particles having a primary particle diameter of less than 0.5 μm within a cumulative volume frequency of 10% to 50%. The lithium titanate powder may contain primary particles having a primary particle diameter of less than 0.55 μm within the range of a cumulative volume frequency of 10% to 55%, or may contain primary particles having a primary particle diameter of less than 0.6 μm within the range of a cumulative volume frequency of 10% to 60%. On the other hand, the lithium titanate powder may contain primary particles having a primary particle diameter of more than 5 μm within the range of a cumulative volume frequency of 50% to 90%, or may contain primary particles having a primary particle diameter of more than 4.5 μm within the range of a cumulative volume frequency of 45% to 85%. The lithium titanate powder may contain primary particles having a primary particle diameter of more than 4 μm within the range of a cumulative volume frequency of 40% to 80%, may contain primary particles having a primary particle diameter of more than 2 μm within the range of a cumulative volume frequency of 15% to 75%, or may contain primary particles having a primary particle diameter of more than 1.8 μm within the range of a cumulative volume frequency of 10% to 72%.

### [Method of Producing Lithium Titanate Powder of the Present Invention]

One example of a method of producing the lithium titanate powder of the present invention will now be described separately with a step of preparing raw materials, a calcination step, and a surface treatment step, but the method of producing the lithium titanate powder of the present invention is not limited to this.

### <Step of Preparing Raw Materials>

The raw materials for the lithium titanate powder of to the present invention are composed of a titanium raw material and a lithium raw material. As the titanium raw material, titanium compounds such as anatase titanium dioxide and rutile titanium dioxide are used. It is preferred that the titanium raw material readily react with the lithium raw material in a short time. From this viewpoint, anatase titanium dioxide is preferred. To sufficiently react the raw materials by calcination in a short time, D50 of the titanium raw material is preferably 5 μm or less.

As the lithium raw material, lithium compounds such as lithium hydroxide monohydrate, lithium oxide, lithium hydrogen carbonate, and lithium carbonate are used.

As for the preparation ratio of the titanium raw material and the lithium raw material, the atomic ratio Li/Ti of Li to Ti may be 0.81 or more and preferably 0.83 or more. This is because if the preparation ratio is low, the lithium titanate powder obtained after calcination will promote the generation of a specific impurity phase, which may adversely affect the battery characteristics.

In the case where a mixture composed of the raw materials above is calcined in a short time in the present invention, before the calcination, the mixed powders constituting the mixture is preferably prepared such that D95 in a particle size distribution curve measured with a laser diffraction/scattering particle size distribution analyzer is 5 μm or less. Here, D95 refers to a particle diameter at which the cumulative volume frequency calculated based on the volume fraction is 95% in cumulation in ascending order of particle diameter.

As the method of preparing the mixture, the methods listed below can be used. A first method is a method of preparing raw materials and then milling and mixing the raw materials at the same time. A second method is a method of milling raw materials until the D95 becomes 5 μm or less and then mixing these raw materials or mixing these materials while lightly milling those. A third method is a method of producing powders each composed of nanoparticles by a method such as crystallization of raw materials, classifying the powders as needed, and then mixing these powders or mixing these powders while lightly milling those. Among these methods, the first method in which mixing of the raw materials and milling thereof are performed at the same time is industrially advantageous because this method has a smaller number of steps. A conductive agent may be added at the same time.

In all of the first to third methods, the raw materials can be mixed by any method, and either wet mixing or dry mixing may be used. For example, Henschel mixers, ultrasonic dispersion apparatuses, homomixers, mortars, ball mills, centrifugal ball mills, planetary ball mills, vibration ball mills, Attritor high-speed ball mills, bead mills, roll mills, etc. can be used.

In the case where the mixture obtained by any of the first to third methods is a mixed powder, it can be fed to the subsequent calcination step without any modification. In the case where the resulting mixture is a mixed slurry of mixed powder, the mixed slurry after dried with a rotary evaporator or the like can be fed to the subsequent calcination step. In the case where the calcination is performed with a rotary kiln furnace, the mixed slurry can be fed as it is into the furnace.

### <Calcination Step>

The resulting mixture is then calcined. From the viewpoint of reducing the ratio of the specific impurity phase, increasing the crystallinity of the lithium titanate, and increasing the crystallite size and the primary particle diameter of the powder, the highest temperature during the calcination is 800° C. or higher and preferably 810° C. or higher. From the viewpoint of increasing the specific surface area of the powder obtained by the calcination and reducing the amount of impurities derived from the furnace tube, the highest temperature during the calcination is 1100° C. or lower, preferably 1000° C. or lower, and more preferably 960° C. or lower. From the above two viewpoints, the retention time at the highest temperature during the calcination is 2 to 60 minutes, preferably 5 to 45 minutes, and more preferably 5 to 35 minutes. When the highest temperature during the calcination is high, it is preferred to select a shorter retention time. In the heating process during the calcination, from the viewpoint of increasing the crystallite size obtained by the calcination, the residence time at 700° C. to 800° C. is preferably shortened, for example, within 15 minutes.

Any calcination method that can be performed under the above conditions can be used. Examples of usable calcination methods include fixed bed calcination furnaces, roller hearth calcination furnaces, mesh belt calcination furnaces, fluidized bed calcination furnaces, and rotary kiln calcination furnaces. In the case where the calcination is efficiently performed in a short time, roller hearth calcination furnaces, mesh belt calcination furnaces, and rotary kiln calcination furnaces are preferred. When a roller hearth calcination furnace or a mesh belt calcination furnace which performs calcination with the mixture accommodated in a sagger is used, a small amount of mixture is preferably accommodated in the sagger to ensure the uniformity of the temperature distribution of the mixture during the calcination and yield the lithium titanate powder with a constant level of quality.

The rotary kiln calcination furnace is a particularly preferred calcination furnace to produce the lithium titanate powder of the present invention because any container which accommodates the mixture is unnecessary, the calcination can be performed while the mixture is continuously being fed, and the calcined product has a uniform thermal history to generate homogeneous lithium titanate powder.

Irrespective of the calcination furnace, the calcination can be performed in any atmosphere in which desorbed water and carbon dioxide gas can be removed. Although the atmosphere is usually an air atmosphere using compressed air, an oxygen, nitrogen, or hydrogen atmosphere may also be used.

The lithium titanate powder after the calcination has agglomerated to a small extent, but does not need to be milled to break particles. For this reason, after the calcination, disintegration to loosen the agglomerates or classification may be performed as needed. If only disintegration to loosen the agglomerates is performed without milling, the lithium titanate powder after the calcination maintains high crystallinity even after the disintegration.

### <Surface Treatment Step>

The lithium titanate powder of the present invention, which is a lithium titanate powder containing one or more metal elements selected from Al, W, Ce, and Mo, can form a dense negative electrode and impart excellent initial discharge capacity, initial efficiency, and charge rate characteristics when applied as a negative electrode material for an all-solid-state secondary battery. In the calcination step, a compound containing the metal elements (which may be referred to as a treatment agent, hereinafter) can be added to produce the lithium titanate powder of the present invention, but more preferably, the lithium titanate powder of the present invention can be produced by a surface treatment step or the like as below.

The lithium titanate powder before the surface treatment prepared through the steps above (Such lithium titanate powder may be referred to as lithium titanate base powder, hereinafter. Likewise, the lithium titanate particles constituting the lithium titanate base powder may be referred to as lithium titanate base particles, hereinafter.) is mixed with a treatment agent, and the mixture is preferably subjected to a heat treatment.

When the metal element selected from the one or more metal elements selected from Al, W, Ce, and Mo is Al, examples of the compound (treatment agent) containing Al include, but are not particularly limited to, oxides, hydroxides, sulfate compounds, nitrate compounds, fluorides, and organic compounds of aluminum and metal salt compounds containing aluminum. Specific examples of the compound containing Al include aluminum acetate, aluminum fluoride, and aluminum sulfate. When the metal element is W, examples of the compound containing W include, but are not particularly limited to, tungsten oxide, tungsten trioxide, tungsten trioxide hydrate, tungsten boride, phosphotungstic acid, tungsten disilicide, tungsten chloride, tungsten sulfate, silicotungstic acid hydrate, sodium tungsten oxide, tungsten carbide, tungsten acetate dimer, lithium tungstate, sodium tungstate, potassium tungstate, calcium tungstate, magnesium tungstate, manganese tungstate, and ammonium tungstate. When the metal element is Ce, examples of the compound containing Ce include, but are not particularly limited to, cerium oxide, cerium sulfide, cerium hydroxide, cerium fluoride, cerium sulfate, cerium nitrate, cerium carbonate, cerium acetate, cerium oxalate, cerium chloride, cerium boride, and cerium phosphate. When the metal element is Mo, examples of the compound containing Mo include, but are not particularly limited to, molybdenum oxide, molybdenum trioxide, molybdenum trioxide hydrate, molybdenum boride, phosphomolybdic acid, molybdenum disilicide, molybdenum chloride, molybdenum sulfide, silicomolybdic acid hydrate, sodium molybdenum oxide, molybdenum carbide, molybdenum acetate dimer, lithium molybdate, sodium molybdate, potassium molybdate, calcium molybdate, magnesium molybdate, manganese molybdate, and ammonium molybdate. Among these compounds, aluminum sulfate and its hydrate, aluminum fluoride, lithium tungstate, cerium sulfate and its hydrate, and lithium molybdate are preferred.

The compound (treatment agent) containing one or more metal elements selected from Al, W, Ce, and Mo may be added in any amount as long as the amount of the metal elements in the lithium titanate powder falls within the range specified in the present invention, but may be added in a proportion of 0.1 mass % or more of the lithium titanate base powder. The compound may be added in a proportion of 12 mass % or less, preferably 10 mass % or less, and more preferably 8 mass % or less of the lithium titanate base powder. Two or more treatment agents may be used in combination.

The mixing method for the lithium titanate base powder and the compound containing the metal elements is not particularly limited, and either wet mixing or dry mixing can be used, but it is preferred to uniformly disperse the compound containing the metal elements on the surfaces of the lithium titanate base particles, and in this respect the wet mixing is preferred.

In the dry mixing, for example, paint mixers, Henschel mixers, ultrasonic dispersion apparatuses, homomixers, mortars, ball mills, centrifugal ball mills, planetary ball mills, vibration ball mills, Attritor high-speed ball mills, bead mills, roll mills, etc. can be used.

In the wet mixing, the treatment agent and the lithium titanate base powder are put into water or an alcohol solvent and mixed in a slurry state. Preferred examples of the alcohol solvent include those having a boiling point of 100° C. or lower, such as methanol, ethanol, and isopropyl alcohol, because these solvents are easy to remove. An aqueous solvent is industrially preferred because it is easy to recover and discard.

Although the amount of solvent is non-problematic if the treatment agent and the lithium titanate base particles are sufficiently wet, it is sufficient that the treatment agent and the lithium titanate base particles are uniformly dispersed in the solvent. For this purpose, the solvent is preferably used in an amount such that the amount of the treatment agent dissolved in the solvent is 50% or more of the total amount of the treatment agent added to the solvent. The amount of the treatment agent dissolved in the solvent increases at higher temperature. Accordingly, the mixing of the lithium titanate base powder with the treatment agent in the solvent is preferably performed under heating. In addition, the amount of solvent can be reduced by the heating. For this reason, the mixing method under heating is industrially suitable. The temperature during the mixing is preferably 40° C. to 100° C. and more preferably 60° C. to 100° C.

In the case of wet mixing, although depending on the heat treatment method, the solvent is preferably removed before the heat treatment, which is performed after the mixing step. The solvent is preferably removed by evaporating the solvent into dryness. Examples of the method of evaporating the solvent into dryness include a method of evaporating the solvent by heating a slurry while stirring the slurry with a stirring blade, a method using a drying apparatus, such as a conical dryer, which enables drying an object while stirring the object, and a method using a spray dryer. If the heat treatment is performed using a rotary kiln furnace, mixed raw materials in the form of slurry can be fed into the furnace.

It is preferred to perform heat treatment after mixing the lithium titanate base powder and the treatment agent. The temperature for the heat treatment is preferably a temperature at which the metal elements diffuse to at least surface regions of the lithium titanate base particles without causing a significant reduction in the specific surface areas of the lithium titanate base particles, which is caused as a result of sintering of the lithium titanate base particles. The upper limit of the temperature for the heat treatment may be 700° C. or lower and preferably 600° C. or lower. The lower limit of the temperature for the heat treatment may be 300° C. or higher and preferably 400° C. or higher. The time for the heat treatment may be 0.1 to 8 hours and preferably 0.5 to 5 hours. The temperature and the time for the metal elements to diffuse to at least the surface regions of the lithium titanate base particles may be set as appropriate because the reactivity varies according to the compound containing the metal elements.

Any heating method can be used in the heat treatment. Examples of usable heat treatment furnaces include fixed bed calcination furnaces, roller hearth calcination furnaces, mesh belt calcination furnaces, fluidized bed calcination furnaces, and rotary kiln calcination furnaces. The atmosphere during the heat treatment may be either an air atmosphere or an inert atmosphere such as a nitrogen atmosphere.

The lithium titanate powder thus obtained after the heat treatment has agglomerated to a small extent, but does not need to be milled to break particles. For this reason, after the heat treatment, disintegration to loosen the agglomerates or classification may be performed as needed.

The lithium titanate powder of the present invention may be formed into a powder containing secondary particles, which are agglomerates of primary particles, by mixing the lithium titanate powder with the treatment agent in the surface treatment step, and then performing granulation and a heat treatment on the mixture. Any granulation method which enables formation of secondary particles can be used. Preferred is a spray dryer because a large amount of powder can be treated.

The dew point may be managed in the heat treatment step to reduce the water content in the lithium titanate powder of the present invention. The water content in the powder after the heat treatment increases if the powder is exposed to air as it is. For this reason, handling of the powder under an environment where the dew point is managed is preferred during cooling in the heat treatment furnace and after the heat treatment. The powder after the heat treatment may be classified as needed to control the diameters of the particles within the range of a desired maximum particle diameter. If the dew point is managed in the heat treatment step, the lithium titanate powder of the present invention is preferably sealed in an aluminum-laminated bag or the like and then taken out to an environment where the dew point is not managed. Even under the dew point management, if the lithium titanate powder after the heat treatment is milled, intake of water from milled faces is facilitated to increase the water content in the powder. For this reason, it is preferred that milling be not performed when the heat treatment has been performed. As for heat treatment conditions, the temperature and retention time within specific ranges significantly affect the form of secondary particles and the surface treatment step. The heat treatment temperature may be 450° C. or higher and 550° C. or lower. This is because if the heat treatment temperature exceeds 550° C., the specific surface area greatly decreases, and the battery performance, particularly the charge rate characteristics, significantly deteriorate. The retention time is preferably 1 hour or more. This is because it is inferred that if the retention time is short, the water content in the powder will increase and the particle surface state will be affected.

### <Periodic Table>

Periodic Table in the present invention refers to the periodic table of long-period elements based on the regulations of the IUPAC (International Union of Pure and Applied Chemistry).

### «Inorganic Solid Electrolyte»

The inorganic solid electrolyte is a solid electrolyte that is inorganic, and the solid electrolyte is an electrolyte that is solid and can move ions inside it (an electrolyte that exhibits a solid state at a temperature of 25° C.). Since inorganic solid electrolytes are solid in the steady state, they are usually not dissociated or released into cations and anions. The inorganic solid electrolyte is not particularly limited as long as it has conductivity for metal ions belonging to Group 1 of Periodic Table, and generally has almost no electron conductivity.

In the present invention, the inorganic solid electrolyte has the conductivity for metal ions belonging to Group 1 of Periodic Table. Representative examples of the inorganic solid electrolyte include (A) a sulfide inorganic solid electrolyte and (B) an oxide inorganic solid electrolyte. In the present invention, the sulfide solid electrolyte is preferably used because it has high ion conductivity and can form a dense compact having few grain boundaries only by applying pressure at room temperature.

### (A) Sulfide Inorganic Solid Electrolyte

The sulfide-based inorganic solid electrolyte preferably contains sulfur atoms (S) and has conductivity for metal ions belonging to Group 1 of Periodic Table and electron insulation properties. The sulfide-based inorganic solid electrolyte can be produced by reacting a metal sulfide belonging to Group 1 of Periodic Table with at least one sulfide represented by the following general formula (III). Two or more sulfides represented by the following general formula (III) may also be used in combination.

MₓS_{y} (III)

(M represents any one of P, Si, Ge, B, Al, Ga, and Sb, and x and y each represent a number that gives a stoichiometric ratio depending on the type of M.)

The metal sulfide belonging to Group 1 of Periodic Table represents any one of lithium sulfide, sodium sulfide, and potassium sulfide. Lithium sulfide and sodium sulfide are more preferred, and lithium sulfide is further preferred.

The sulfide represented by the general formula (III) is preferably any one of P₂S₅, SiS₂, GeS₂, B₂S₃, Al₂S₃, Ga₂S₃, and Sb₂S₅, and P₂S₅ is particularly preferred.

The composition ratio of elements in the sulfide inorganic solid electrolyte produced as described above can be controlled by adjusting the compounding amounts of the metal sulfide belonging to Group 1 of Periodic Table, the sulfide represented by the general formula (III), and elemental sulfur.

The sulfide inorganic solid electrolyte of the present invention may be amorphous glass, crystallized glass, or a crystalline material.

As the sulfide inorganic solid electrolyte, the following combinations are specifically suitable, but are not particularly limited.

Li₂S—P₂S₅, Li₂S—P₂S₅—Al₂S₃, Li₂S—GeS₂, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, and Li₁₀GeP₂S₁₂.

Among the above combinations, LPS glass and LPS glass ceramics produced by combining Li₂S—P₂S₅ are preferred.

The mixing ratio of the metal sulfide belonging to Group 1 of Periodic Table and the sulfide represented by the general formula (III) is not particularly limited as long as the reaction product can be used as a solid electrolyte, but the ratio is preferably 50:50 to 90:10 (molar ratio). When the molar ratio of the metal sulfide is 50 or more and 90 or less, the ion conductivity can be sufficiently enhanced. The mixing ratio (molar ratio) is more preferably 60:40 to 80:20 and further preferably 70:30 to 80:20.

To enhance the ion conductivity, the sulfide inorganic solid electrolyte may contain at least one lithium halide selected from LiI, LiBr, LiCl, and LiF, or a lithium oxide, or a lithium salt such as lithium phosphate in addition to the metal sulfide belonging to Group 1 of Periodic Table and the sulfide represented by the general formula (III). The mixing ratio of the sulfide inorganic solid electrolyte and such a lithium salt is preferably 60:40 to 95:5 (molar ratio) and more preferably 80:20 to 95:5.

In addition to the above, suitable examples of the sulfide inorganic solid electrolyte include argyrodite-type solid electrolytes such as Li₆PS₅Cl and Li₆PS₅Br.

Examples of the method for producing the sulfide inorganic solid electrolyte include, but are not particularly limited to, a solid phase method, a sol-gel method, a mechanical milling method, a solution method, and a melt quenching method.

### (B) Oxide Inorganic Solid Electrolyte

The oxide-based inorganic solid electrolyte preferably contains oxygen atoms (S) and has conductivity for metal ions belonging to Group 1 of Periodic Table and electron insulation properties.

Preferred examples of the oxide inorganic solid electrolyte include Li_{3.5}Zn_{0.25}GeO₄ having a LISICON (lithium superionic conductor) type crystal structure, La_{0.55}Li_{0.35}TiO₃ having a perovskite type crystal structure, LiTi₂P₃O₁₂ having a NASICON (Na superionic conductor) type crystal structure, Li₇La₃Zr₂O₁₂ (LLZ) having a garnet type crystal structure, lithium phosphate (Li₃PO₄), LiPON in which part of oxygen of lithium phosphate is substituted with nitrogen, Li₃BO₃—Li₂SO₄, Li₂O—B₂O₃—P₂O₅, Li₂O—SiO₂, and Li₆BaLa₂Ta₂O₁₂.

The volume average particle diameter of the inorganic solid electrolyte is not particularly limited, but may be 0.01 μm or more and preferably 0.1 μm or more. The upper limit may be 100 μm or less and preferably 50 μm or less. The volume average particle diameter of the inorganic solid electrolyte can be measured using a laser diffraction/scattering particle size distribution analyzer.

The content of the inorganic solid electrolyte is not particularly limited, but may be 1 mass % or more, preferably 5 mass % or more, more preferably 20 mass % or more, and further preferably 30 mass % or more in the negative electrode active material composition. The higher the content of the inorganic solid electrolyte, the easier it is to obtain contact between the lithium titanate powder and the solid electrolyte, which is preferred. If the content of the inorganic solid electrolyte is unduly large, the battery capacity of the all-solid-state secondary battery will be small, so the content may be 70 mass % or less and preferably 50 mass % or less. Usually, the content of the inorganic solid electrolyte is preferably as small as possible in order to increase the battery capacity of the all-solid-state secondary battery, but if the content is small, it will be difficult to make contact between the lithium titanate powder and the solid electrolyte. By using the lithium titanate powder used in the negative electrode active material composition of the present invention, it is possible to obtain satisfactory contact between the lithium titanate powder and the solid electrolyte even when the content of the inorganic solid electrolyte is small. The content ratio of the lithium titanate powder and the inorganic solid electrolyte in the negative electrode active material composition is preferably 99:1 to 30:70, more preferably 95:5 to 40:60, further preferably 80:20 to 50:50, and particularly preferably 75:25 to 50:50 in terms of the mass ratio of “Lithium titanate powder:Inorganic solid electrolyte.”

### «Other Inclusions»

The negative electrode active material composition of the present invention may contain a conductive agent and a binder in addition to the lithium titanate powder and the inorganic solid electrolyte.

The conductive agent for the negative electrode can be any electron conductive material which does not chemically change. Examples thereof include graphites such as natural graphite (flake graphite, etc.) and artificial graphite; carbon blacks such as acetylene black, Ketjen black, channel black, furnace black, lamp black, and thermal black; and carbon nanotubes such as single-walled carbon nanotubes, multi-walled carbon nanotubes (multi-layer of cylindrical graphite layers concentrically disposed) (non-fishbone-like), cup stacked-type carbon nanotubes (fishbone-like)), node-type carbon nanofibers (non-fishbone-like structure), and platelet-type carbon nanofibers (stacked card-like). Graphites, carbon blacks, and carbon nanotubes may be appropriately mixed and used. Although not particularly limited, carbon blacks have a specific surface area of preferably 30 to 3000 m²/g and more preferably 50 to 2000 m²/g. Graphites have a specific surface area of preferably 30 to 600 m²/g and more preferably 50 to 500 m²/g. Carbon nanotubes have an aspect ratio of 2 to 150, preferably 2 to 100, and more preferably 2 to 50.

While the amount of conductive agent to be added varies according to the specific surface area of the active material or the types and combination of conductive agents and therefore should be optimized, the content in the negative electrode active material composition may be 0.1 to 10 mass % and preferably 0.5 to 5 mass %. When the amount of conductive agent to be added falls within a range of 0.1 to 10 mass %, the active material ratio is made sufficient thereby to further enhance the conductivity of the negative electrode layer while allowing the initial discharge capacity of the electricity storage device per unit mass and unit volume of the negative electrode layer to be sufficient.

Examples of the binder for the negative electrode include poly(tetrafluoroethylene) (PTFE), poly(vinylidene fluoride) (PVDF), poly(vinylpyrrolidone) (PVP), copolymer of styrene and butadiene (SBR), copolymer of acrylonitrile and butadiene (NBR), and carboxymethyl cellulose (CMC). Although not particularly limited, poly(vinylidene fluoride) preferably has a molecular weight of 20000 to 1000000. From the viewpoint of further enhancing the binding properties of the negative electrode layer, the molecular weight is preferably 25000 or more, more preferably 30000 or more, and further preferably 50000 or more. To further enhance the conductivity without obstructing the contact between the active material and the conductive agent, the molecular weight is preferably 500000 or less. In particular, when the active material has a specific surface area of 10 m²/g or more, the molecular weight is preferably 100000 or more.

While the amount of binder to be added varies according to the specific surface area of the active material or the types and combination of conductive agents and therefore should be optimized, the content of the binder in the negative electrode active material composition may be 0.2 to 15 mass %. To enhance the binding properties and ensure the strength of the negative electrode layer, the content is preferably 0.5 mass % or more, more preferably 1 mass % or more, and further preferably 2 mass % or more. To prevent a reduction in proportion of the active material and a reduction in the initial discharge capacity of the energy storage device per unit mass and unit volume of the negative electrode layer, the content is preferably 10 mass % or less and more preferably 5 mass % or less.

### «Method of Preparing Negative Electrode Active Material Composition»

Examples of the method of preparing the negative electrode active material composition of the present invention include, but are not particularly limited to, a method of adding a specific proportion of the inorganic solid electrolyte powder to the lithium titanate powder and mixing them with a mixer, a stirrer, a disperser, or the like and a method of adding the lithium titanate powder to a slurry containing a solid electrolyte.

The reason why the negative electrode active material composition of the present invention can provide a dense negative electrode layer having fewer voids than conventional ones and excellent initial discharge characteristics, initial efficiency, and charge rate characteristics in an all-solid-state secondary battery is not necessarily clear, but can be considered as follows.

The negative electrode active material composition of the present invention includes the inorganic solid electrolyte having conductivity for metal ions belonging to Group 1 of Periodic Table and the lithium titanate powder containing one or more metal elements selected from Al, W, Ce, and Mo that are present on surfaces of lithium titanate particles. Usually, upon mixing of lithium titanate and an inorganic solid electrolyte, the lithium titanate particles agglomerate together especially when the particle diameter of the lithium titanate powder is small, and the lithium titanate powder and the solid electrolyte are not uniformly mixed in the negative electrode active material composition. As a result, only a negative electrode active material composition having many voids and a low relative density ratio can be obtained. On the other hand, the presence of metal elements such as Al, W, Ce, and Mo on the surfaces of the lithium titanate particles of the present invention suppresses the agglomeration of the lithium titanate particles, and furthermore, the affinity with the inorganic solid electrolyte, particularly with sulfide solid electrolyte, is enhanced to enable uniform mixing in the negative electrode active material composition. As a result, the solid electrolyte and the lithium titanate powder of the present invention can form a good solid-solid interface in the negative electrode active material composition, and a dense negative electrode layer having fewer voids than conventional ones can be formed. It is thus considered that the characteristics can be improved in the all-solid-state secondary battery.

Here, in a lithium-ion secondary battery using an organic electrolytic solution, even if lithium titanate particles agglomerate together, the agglomerated portions are also easily impregnated with the organic electrolytic solution which serves as a carrier for metal ions such as lithium ions. Hence, since a solid-liquid interface is easily formed, even in such agglomerated portions, metal ions such as lithium ions can undergo absorption and desorption reactions via the organic electrolytic solution. Thus, in a secondary battery using an organic electrolytic solution, such agglomeration of lithium titanate particles rarely causes a problem. On the other hand, in an all-solid-state secondary battery, the inorganic solid electrolyte, which serves as a carrier for metal ions such as lithium ions, cannot enter such agglomerated portions, and no solid-solid interface is formed. As a result, the absorption and desorption reactions of metal ions such as lithium ions are not performed and cannot contribute to the battery reaction. That is, the problem of agglomeration of lithium titanate particles is a problem peculiar to all-solid-state secondary batteries using an inorganic solid electrolyte, and in particular, this problem becomes more pronounced as the particle diameter of the lithium titanate particles becomes smaller. In this context, according to the present invention, the presence of metal elements such as Al, W, Ce, and Mo on the surfaces of the lithium titanate particles suppresses the agglomeration of the lithium titanate particles, and furthermore, the affinity with the inorganic solid electrolyte, particularly with sulfide solid electrolyte, can be enhanced thereby to obtain a dense negative electrode layer having fewer voids than conventional ones, thus effectively solving the problem caused by the occurrence of agglomerated portions as described above.

The negative electrode active material composition of the present invention can be used for the negative electrodes of all-solid-state secondary batteries. In this case, it is preferred to perform pressure molding of the negative electrode active material composition of the present invention to form a pressure-molded compact. The conditions for pressure molding are not particularly limited, but the molding temperature may be 15° C. to 200° C. and preferably 25° C. to 150° C., and the molding pressure may be 180 MPa to 1080 MPa and preferably 300 MPa to 800 MPa. The negative electrode active material composition of the present invention can form a dense molded compact having few voids, and therefore can form a dense negative electrode layer having few voids. The compact obtained using the negative electrode active material composition of the present invention has a filling rate of 72.5% to 100% and preferably 73.5% to 100%. A method for measuring the filling rate will be described in Examples, which will be described later.

«all-Solid-State Secondary Battery»

The all-solid-state secondary battery of the present invention is composed of a positive electrode, a negative electrode, and a solid electrolyte layer positioned between the positive electrode and the negative electrode. The negative electrode active material composition, which includes a lithium titanate powder whose main component is Li₄Ti₅O₁₂ and an inorganic solid electrolyte having conductivity for metal ions belonging to Group 1 of Periodic Table, is used for the negative electrode layer. The method of preparing the negative electrode layer is not particularly limited, and preferred examples of the method include a method of pressure-molding the negative electrode active material composition and a method of adding the negative electrode active material composition to a solvent to form a slurry, then applying the negative electrode active material composition to a current collector, and drying and pressure-molding it.

Examples of the negative electrode current collector include aluminum, stainless steel, nickel, copper, titanium, calcined carbon, and those whose surfaces are coated with carbon, nickel, titanium, or silver. Additionally or alternatively, the surfaces of these materials may be oxidized, or may be subjected to a surface treatment to form depressions and projections on the surface of the negative electrode current collector. Examples of forms of the negative electrode current collector include formed bodies of sheets, nets, foils, films, punched materials, lath bodies, porous bodies, foamed bodies, fiber groups, and nonwoven fabrics. The negative electrode current collector is preferably formed of porous aluminum. The porous aluminum has a porosity of 80% or more and 95% or less and preferably 85% or more and 90% or less.

Provided that a negative electrode layer containing the negative electrode active material composition of the present invention is included, constituent members such as a positive electrode layer and a solid electrolyte layer can be used without particular limitations.

As a positive electrode active material used as the positive electrode layer for an all-solid-state secondary battery, for example, a composite metal oxide with lithium that contains one or more selected from the group consisting of cobalt, manganese, and nickel is used. One of these positive electrode active materials may be used alone or two or more may also be used in combination.

Preferred examples of such lithium composite metal oxides include one or more of, more preferably two or more of, LiCoO₂, LiCo₁₋ₓMₓO₂ (where M is one or more elements selected from Sn, Mg, Fe, Ti, Al, Zr, Cr, V, Ga, Zn, and Cu, 0.001≤x≤0.05), LiMn₂O₄, LiNiO₂, LiCo₁₋ₓNiₓO₂ (0.01<x<1), LiCo_{1/3}Ni_{1/3}Mn_{1/3}O₂, LiNi_{0.5}Mn_{0.3}Co_{0.2}O₂, LiNi_{0.8}Mn_{0.1}Co_{0.1}O₂, LiNi_{0.8}Co_{0.15}Al_{0.05}O₂, a solid solution of Li₂MnO₃ and LiMO₂ (M is a transition metal such as Co, Ni, Mn, or Fe), and LiNi_{1/2}Mn_{3/2}O₄. Combinations may also be used, such as LiCoO₂ and LiMn₂O₄, LiCoO₂ and LiNiO₂, and LiMn₂O₄ and LiNiO₂.

A lithium-containing olivine-type phosphate can also be used as the positive electrode active material. Lithium-containing olivine-type phosphate that contains one or more selected from iron, cobalt, nickel, and manganese is particularly preferred. Specific examples thereof include LiFePO₄, LiCoPO₄, LiNiPO₄, and LiMnPO₄.

Part of such a lithium-containing olivine-type phosphate may be substituted with another element, and part of iron, cobalt, nickel, or manganese may be substituted with one or more elements selected from Co, Mn, Ni, Mg, Al, B, Ti, V, Nb, Cu, Zn, Mo, Ca, Sr, W, Zr, etc., or can be coated with a compound or carbon material that contains such other elements. Among these, LiFePO₄ or LiMnPO₄ is preferred.

The lithium-containing olivine-type phosphate can be used, for example, by being mixed with the positive electrode active material.

There are no particular limitations on the conductive agent for the positive electrode as long as it is an electronically conductive material that does not cause chemical changes. Examples thereof include graphites such as natural graphite (flake graphite, etc.) and artificial graphite and carbon blacks such as acetylene black, Ketjen black, channel black, furnace black, lamp black, and thermal black. Graphite and carbon black may be mixed and used as appropriate. The amount of the conductive agent added to the positive electrode active material composition is preferably 1 to 10 mass % and particularly preferably 2 to 5 mass %.

The positive electrode active material composition contains at least the positive electrode active material and the solid electrolyte, and if necessary, may contain a conductive agent such as acetylene black or carbon black, a binder such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), ethylene propylene diene terpolymer, etc. The method of preparing the positive electrode is not particularly limited, and preferred examples of the method include a method of pressure-molding the powder of the positive electrode active material composition and a method of adding the powder of the positive electrode active material composition to a solvent to form a slurry, then applying the positive electrode active material composition to an aluminum foil or a stainless steel lath plate as a current collector, and drying and pressure-molding it.

The surface of the positive electrode active material may be surface-coated with another metal oxide. Examples of surface coating agents include metal oxides and the like that contain Ti, Nb, Ta, W, Zr, Al, Si, or Li. Specific examples include Li₄Ti₅O₁₂, Li₂Ti₂O₅, LiTaO₃, LiNbO₃, LiAlO₂, Li₂ZrO₃, Li₂WO4, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

The solid electrolyte layer is positioned between the positive electrode and the negative electrode, and the thickness of the solid electrolyte layer may be, but is not particularly limited to, 1 to 100 μm. Usable constituent material of the solid electrolyte layer may be the sulfide solid electrolyte or the oxide solid electrolyte, and may be different from the solid electrolyte used for the electrodes. The solid electrolyte layer may contain a binder such as butadiene rubber or butyl rubber.

There are no particular limitations on the structure of the all-solid-state secondary battery, and coin-shaped batteries, cylindrical batteries, rectangular batteries, laminate batteries, etc. can be applied.

### EXAMPLES

The present invention will now be more specifically described by way of Examples and Comparative Examples, but the present invention is not limited to Examples below, and encompasses a variety of combinations which can be easily analogized from the gist of the present invention.

### Production Example 1

### <Step of Preparing Raw Materials>

Li₂CO₃ (average particle diameter: 4.6 μm) and TiO₂ (specific surface area: 10 m²/g) were weighed such that the atomic ratio of Li to Ti (Li/Ti) was 0.83. A raw material powder was thereby prepared. Deionized water was added to and stirred with the raw material powder to give a raw material mixed slurry having a solid content of 41 mass %. Using a bead mill (made by Willy A. Bachofen AG, type: DYNO-MILL KD-20BC, material for the agitator: polyurethane, material for the vessel inner surface: zirconia) including a vessel 80 vol % filled with zirconia beads (outer diameter: 0.65 mm), this raw material mixed slurry was processed at an agitator circumferential speed of 13 m/s and a slurry feed rate of 55 kg/hr under control such that the vessel internal pressure was 0.02 to 0.03 MPa and the raw material powder was wet mixed and milled.

### <Calcination Step>

Using a rotary kiln calcination furnace (length of the furnace core tube: 4 m, diameter of the furnace core tube: 30 cm, external heating type) provided with an anti-adhesion mechanism, the resulting mixed slurry was introduced into the furnace core tube from the raw material feed zone of the calcination furnace, and was dried and calcined in a nitrogen atmosphere. In this operation, the tilt angle of the furnace core tube to the horizontal direction was 2.5 degrees, the rotational speed of the furnace core tube was 20 rpm, and the flow rate of nitrogen introduced from the calcined product recovery zone into the furnace core tube was 20 L/min. The heating temperature of the furnace core tube was 600° C. in the raw material feed zone, 840° C. in the central zone, and 840° C. in the calcined product recovery zone. The retention time of the calcined product at 840° C. was 30 minutes.

### <Post-Treatment Step>

The calcined product recovered from the calcined product recovery zone of the furnace core tube was disintegrated at a screen opening of 0.5 mm, the number of rotations of 8,000 rpm, and a powder feed rate of 25 kg/hr using a hammer mill (made by DALTON CORPORATION, AIIW-5).

### <Surface Treatment Step>

Deionized water was added to and stirred with the calcined powder subjected to disintegration to give a slurry having a solid content of 30 mass %. Then, aluminum sulfate hexadecahydrate (Al₂(SO₄)₃·16H₂O) as the treatment agent was added in an amount of 1.6 mass % of the calcined powder subjected to disintegration, to prepare a mixed slurry. This mixed slurry was sprayed and dried using a spray dryer (L-8i manufactured by OHKAWARA KAKOHKI CO., LTD.) at an atomizer rotation speed of 25000 rpm and a drying temperature of 250° C. and granulated. Then, the powder passing through the sieve was placed in an alumina sagger and subjected to a heat treatment at 500° C. for one hour in a mesh belt conveying-type continuous furnace having an outlet provided with a recovery box in which the temperature was 25° C. and the dew point was managed at −20° C. or lower. The powder after the heat treatment was cooled and sieved (screen opening: 53 mm) inside the recovery box, the powder passing through the sieve was collected and sealed in an aluminum laminated bag, and then the bag was extracted from the recovery box. The lithium titanate powder was thus produced.

### Production Examples 2 to 8 and Production Examples 1a to 5a

As listed in Table 1, lithium titanate powders were produced in the same manner as in Production Example 1. In Production Examples 4 to 7 and Production Example 5a, lithium molybdate (Li₂MoO₄) was used as a treatment agent in addition to the aluminum sulfate hexadecahydrate (Al₂(SO₄)₃·16H₂O) and added at the same timing as the aluminum sulfate hexadecahydrate (Al₂(SO₄)₃·16H₂O). In Production Examples 2a and 3a, lithium molybdate (Li₂MoO₄) and lithium tungstate (Li₂WO4) were used as treatment agents instead of the aluminum sulfate hexadecahydrate (Al₂(SO₄)₃·16H₂O) and the timing of addition was the same as that of the aluminum sulfate hexadecahydrate (Al₂(SO₄)₃·16H₂O). In Production Example 4a, cerium sulfate tetrahydrate (Ce₂(SO₄)₃·4H₂O) was used as a treatment agent instead of the aluminum sulfate hexadecahydrate (Al₂(SO₄)₃·16·H₂O) and the timing of addition was the same as that of the aluminum sulfate hexadecahydrate (Al₂(SO₄)₃·16H₂O).

### [Measurement of Metal Element Content Ratio]

The content ratios of metal elements contained in the lithium titanate powders of Production Examples 1 to 7 and Production Examples 1a to 5a were measured as follows.

### <X-Ray Fluorescence Analysis (XRF): Identification of Metal Elements>

Using an X-ray fluorescence analyzer (manufactured by SII Technology Co., Ltd., trade name “SPS5100”), the elements contained in the lithium titanate powder according to each of Examples and Comparative Examples were subjected to quantitative analysis.

### [Measurement of Powder Physical Properties]

A variety of physical properties of the lithium titanate powder according to each of Production Examples were measured as follows.

### <Measurement of Specific Surface Area>

The specific surface area (m²/g) of the lithium titanate powder according to each of Production Examples was measured using an automatic BET specific surface area analyzer (made by Mountech Co., Ltd., trade name “Macsorb HM model-1208”), and nitrogen gas was used as the absorption gas. Specifically, 0.5 g of sample powder to be measured was weighed, placed into a 912 standard cell (HM1201-031), degassed at 100° C. under vacuum for 0.5 hours, and then measured by a BET single-point method.

### <Calculation of D50 of Primary Particles: Dry Laser Diffraction Scattering Method>

The D50 of the lithium titanate powder according to each of Production Examples was calculated from a particle size distribution curve measured using a laser diffraction/scattering particle size distribution analyzer (manufactured by NIKKISO CO., LTD., Microtrac MT3300EXII). Specifically, 50 mg of sample was put into a container containing 50 ml of deionized water as a measurement solvent, the container was shaken by hand until the powder was visually confirmed to be evenly dispersed in the measurement solvent, and the container was placed in a measurement cell for measurement. The disintegration treatment was performed by applying ultrasonic waves (30 W, 3 s) with an ultrasonic device in the apparatus. The measurement solvent was further added until the transmittance of the slurry fell within an appropriate range (the range indicated by the green bar of the apparatus), and the particle size distribution was measured. The D50 of the mixed powder after disintegration was calculated from the obtained particle size distribution curve.

### <Atomic Concentrations of Metal Elements in Cross-Section of Lithium Titanate Particle (Scanning Transmission Electron Microscope (STEM))>

For the lithium titanate powder according to each of Production Examples 1 and 7, cross-sectional analysis of the lithium titanate particles was performed using a scanning transmission electron microscope (STEM), and the atomic concentrations of the metal elements were measured by energy dispersive X-ray spectroscopy (EDS). The measurement was performed by the following method.

Lithium titanate particles were bonded to a dummy substrate with an epoxy resin. The substrate was then cut and bonded to a reinforcing ring, and was subjected to grinding, dimpling, Ar ion milling, and finally carbon deposition to prepare a thin sample.

The atomic concentrations of the metal elements at a specific position of the resulting thin sample of lithium titanate particles were measured by energy dispersive X-ray spectroscopy (EDS) as follows. While a cross-section of the thin sample was being observed at an accelerating voltage of 120 kV using a JEM-2100F field-emission transmission electron microscope (with Cs correction) made by JEOL, Ltd., the atomic concentrations of the metal elements at an inner position of 1 nm and those at an inner position of 100 nm from the surface of the thin sample were measured using an UTW Si (Li) semiconductor detector made by JEOL, Ltd. attached to the microscope, the inner positions being located on a straight line drawn orthogonal to a tangent of the surface of the thin sample from its point of tangency. The beam diameter was 0.2 nm, namely, the analysis region was a circle having a diameter of 0.2 nm. In addition, the lower limit of the amount detected in this measurement was 0.5 atm %. The results are listed in Table 2 in which C1 (atm %) is a total metal element concentration at an inner position of 1 nm from the surfaces of the lithium titanate particles, and C2 (atm %) is the total metal element concentration at a depth position of 100 nm from the surfaces of the lithium titanate particles.

TABLE 1

| | | | Production | Production | Production | Production | Production | Production | Production |
|---|---|---|---|---|---|---|---|---|---|
| | | | Example | Example | Example | Example | Example | Example | Example |
| | | | 1 | 2 | 3 | 1a | 2a | 3a | 4a |
| Preparation | Lithium | Type | Li₂CO₃ | Li₂CO₃ | Li₂CO₃ | Li₂CO₃ | Li₂CO₃ | Li₂CO₃ | Li₂CO₃ |
| of raw | raw | Average | 4.6 | 4.6 | 4.6 | 4.8 | 4.6 | 4.6 | 4.6 |
| materials | material | particle | | | | | | | |
| | | diameter | | | | | | | |
| | | [μm] | | | | | | | |
| | Titanium | Type | Anatase | Anatase | Anatase | Rubile | Anatase | Anatase | Anatase |
| | raw | | TiO₂ | TiO₂ | TiO₂ | TiO₂ | TiO₂ | TiO₂ | TiO₂ |
| | material | Specific | 10 | 10 | 4 | 2 | 10 | 10 | 10 |
| | Mixing | surface | | | | | | | |
| | | area | | | | | | | |
| | | [m²/g] | | | | | | | |
| | Mixing | | Wet | Wet | Wet | Wet | Wet | Wet | Wet |
| | | | bead mil | bead mil | bead mil | bead mil | bead mil | bead mil | bead mil |
| | Form | | Slurry | Slurry | Slurry | Slurry | Slurry | Slurry | Slurry |
| Calcination | Calcination furnace | | Rotary kiln calcination furnace | | | | | | |
| | Highest temperature [° C.] | | 840 | 840 | 840 | 840 | 840 | 840 | 840 |
| | Retention time [min] | | 30 | 30 | 30 | 30 | 30 | 30 | 30 |
| Disintegration | Hammer mill disintegration | | Present | Present | Present | Present | Present | Present | Present |
| Surface | Treatment | Type | Al₂(SO₄)₂• | Al₂(SO₄)₂• | Al₂(SO₄)₂• | Al₂(SO₄)₂• | Li₂MoO₄ | Li₂WO₄ | Co₂(SO₄)₃• |
| treatment | agent 1 | | 16H₂O | 16H₂O | 16H₂O | 16H₂O | | | 4H₂O |
| | | Amount | 1.6 | 3.2 | 1.6 | 1.6 | 0.9 | 1.37 | 1.75 |
| | | [mass %] | | | | | | | |
| | Treatment | Type | — | — | — | — | — | — | — |
| | agent 2 | Amount | — | — | — | — | — | — | — |
| | | [mass %] | | | | | | | |
| | Heat | Temperature | 500 | 500 | 500 | 500 | 500 | 500 | 500 |
| | treatment | [° C.] | | | | | | | |
| | | Time [h] | 1 | 1 | 1 | 1 | 1 | 1 | 1 |

| | | | Production | Production | Production | Production | Production | Production |
|---|---|---|---|---|---|---|---|---|
| | | | Example | Example | Example | Example | Example | Example |
| | | | 4 | 5 | 6 | 7 | 5a | 8 |
| Preparation | Lithium | Type | Li₂CO₃ | Li₂CO₃ | Li₂CO₃ | Li₂CO₃ | Li₂CO₃ | Li₂CO₃ |
| of raw | raw | Average | 4.6 | 4.6 | 4.6 | 4.8 | 4.6 | 4.6 |
| materials | material | particle | | | | | | |
| | | diameter | | | | | | |
| | | [μm] | | | | | | |
| | Titanium | Type | Anatase | Anatase | Anatase | Anatase | Rubile | Anatase |
| | raw | | TiO₂ | TiO₂ | TiO₂ | TiO₂ | TiO₂ | TiO₂ |
| | material | Specific | 10 | 10 | 10 | 10 | 2 | 10 |
| | Mixing | surface | | | | | | |
| | | area | | | | | | |
| | | [m²/g] | | | | | | |
| | Mixing | | Wet | Wet | Wet | Wet | Wet | Wet |
| | | | bead mil | bead mil | bead mil | bead mil | bead mil | bead mil |
| | Form | | Slurry | Slurry | Slurry | Slurry | Slurry | Slurry |
| Calcination | Calcination furnace | | Rotary kiln calcination furnace | | | | | |
| | Highest temperature [° C.] | | 840 | 840 | 840 | 920 | 840 | 840 |
| | Retention time [min] | | 30 | 30 | 30 | 30 | 30 | 30 |
| Disintegration | Hammer mill disintegration | | Present | Present | Present | Present | Present | Present |
| Surface | Treatment | Type | Al₂(SO₄)₂• | Al₂(SO₄)₂• | Al₂(SO₄)₂• | Al₂(SO₄)₂• | Al₂(SO₄)₂• | — |
| treatment | agent 1 | | 16H₂O | 16H₂O | 16H₂O | 16H₂O | 16H₂O | |
| | | Amount | 3.2 | 3.2 | 3.2 | 1.8 | 1.8 | — |
| | | [mass %] | | | | | | |
| | Treatment | Type | Li₂MoO₄ | Li₂MoO₄ | Li₂MoO₄ | Li₂MoO₄ | Li₂MoO₄ | — |
| | agent 2 | Amount | 0.24 | 0.48 | 1.44 | 0.48 | 0.48 | — |
| | | [mass %] | | | | | | |
| | Heat | Temperature | 500 | 500 | 500 | 500 | 500 | — |
| | treatment | [° C.] | | | | | | |
| | | Time [h] | 1 | 1 | 1 | 1 | 1 | — |

TABLE 2

| | | | Production | Production |
|---|---|---|---|---|
| | | | Example | Example |
| | | | 1 | 7 |
| Surface | Treatment | Type | Al₂(SO₄)₂, | Al₂(SO₄)₃, |
| treatment | agent 1 | | 16H₂O | 16H₂O |
| | | Amount | 1.6 | 1.6 |
| | | [mass %] | | |
| | Treatment | Type | — | Li₂MoD₄ |
| | agent 2 | Amount | — | 0.48 |
| | | [mass %] | | |
| | Heat | Temperature | 500 | 500 |
| | treatment | [° C.] | | |
| | | Time [h] | 1 | 1 |
| Metal | Type | | Al | Al |
| elements | Atomic | (Particle surface) | 2.2 | 2.2 |
| | concentration | C1 [atm %] | | |
| | | (Particle inside) | ND | ND |
| | | C2 [atm %] | | |
| | Type | | — | Mo |
| | Atomic | (Particle surface) | — | 3.17 |
| | concentration | C1 [atm %] | | |
| | | (Particle inside) | — | ND |
| | | C2 [atm %] | | |

It is found from Table 2 above that the metal elements are present on the surfaces of the lithium titanate powder used in the present invention. As for the lithium titanate powders produced in Production Examples 2 and 3 and Production Examples 1a to 4a subjected to the surface treatment performed by the same method as that of Production Example 1 and the lithium titanate powders produced in Production Examples 4 to 6 and Production Example 5a subjected to the surface treatment performed by the same method as that of Production Example 7, it is considered that the metal elements corresponding to respective treatment agents are present on the surfaces (e.g., surfaces including positions 1 nm from the surfaces of the lithium titanate particles toward the inside) while the amount of the metal elements is substantially undetected at depth positions of 100 nm from the surfaces of the lithium titanate particles.

### Preparation of Negative Electrode Active Material Composition

### Example 1

In a glove box under an argon atmosphere, the lithium titanate powder of Production Example 1 and the Li₆PS₅Cl powder as a sulfide solid electrolyte (volume average particle diameter obtained using a laser diffraction/scattering particle size distribution analyzer: 6 μm) were weighed such that the mass ratio of lithium titanate:Li6PS5Cl=60:40 was obtained, and mixed in an agate mortar. Then, zirconia balls (diameter 3 mm, 20 g) were put into an 80 mL zirconia pot, and the mixed powder was also put into the pot. After that, this pot was set in a planetary ball mill, and stirring was continued for 15 minutes at a rotation speed of 200 rpm to obtain a negative electrode active material composition of Example 1.

### Examples 2 to 7, Examples 1a to 3a, and Comparative Example 1

Negative electrode active material compositions listed in Table 3 below were prepared in the same manner as in Example 1 except that the lithium titanate powders produced by the production methods listed in Table 1 were used.

### «Measurement of Physical Properties of Negative Electrode Active Material Composition»

The above negative electrode active material compositions were each weighed to be 100 mg, and these samples were pressed (360 MPa) at room temperature for 10 minutes to prepare pellets (compacts) having a diameter of 10 mm and a thickness of about 0.7 mm.

### <Evaluation of Relative Density Ratio>

The filling rate was calculated by the following formula using a density calculated from the pellet density of the negative electrode active material composition calculated from the volume and mass of each of the above pellets, the density (true density) of Li₆PS₅Cl, the density (true density) of the lithium titanate, and the mixing ratio (α; 0<α<1) of the lithium titanate powder in the negative electrode active material composition (α is the content ratio of the lithium titanate powder when the entire negative electrode active material composition is 1).

Filling rate (%)=(pellet density of negative electrode active material composition/((1−α) Li₆PS₅Cl density (true density)+α×lithium titanate density (true density))×100

Then, using the obtained filling rate values, the relative density ratios of the pellets of the negative electrode active material compositions according to Examples 1 to 7 and Examples 1a to 3a were calculated with reference to the value of Comparative Example 1 being 100%. The results are listed in Table 3.

### [Evaluation of Battery Characteristics]

All-solid-state secondary batteries were prepared using the pellets of the negative electrode active material compositions of Examples, and their battery characteristics were evaluated. The results of evaluation are listed in Table 3.

### «Synthesis of Sulfide-Based Inorganic Solid Electrolyte»

In a glove box under an argon atmosphere, lithium sulfide (Li₂S) and diphosphorus pentasulfide (P₂S₅) were weighed such that the molar ratio of Li₂S:P₂S₅ was 75:25, and mixed in an agate mortar. A raw material composition was thus obtained.

Then, zirconia balls (diameter 3 mm, 160 g) and 2 g of the obtained raw material composition were put into an 80 mL zirconia pot, and the container was sealed under an argon atmosphere. This pot was set in a planetary ball mill, and mechanical milling was performed at a rotation speed of 510 rpm for 16 hours to obtain a yellow powdery sulfide solid electrolyte (LPS glass). A pellet-shaped solid electrolyte layer was obtained by pressing 80 mg of the obtained LPS glass at a pressure of 360 MPa using a pellet molding machine having a molding part with an area of 0.785 cm².

«Preparation of all-Solid-State Secondary Battery»

The pellets of the negative electrode active material composition according to each of Examples, the above pellet-shaped solid electrolyte layer, and a lithium indium alloy foil as the counter electrode were laminated in this order, and the laminate was interposed between stainless steel current collectors. All-solid-state secondary batteries were thus prepared.

### <Measurement of Initial Discharge Capacity, Initial Efficiency, and Charge Rate Characteristics>

In a constant temperature bath at 25° C., each coin-type battery prepared by the above-described method was subjected to constant-current and constant-voltage charge with a direction of charge in which Li was absorbed in the electrode to be evaluated. In the constant-current and constant-voltage charge, the battery was charged to 0.5 V with a current corresponding to 0.05C, which is the theoretical capacity of lithium titanate, and further charged at 0.5 V until the charging current reached a current corresponding to 0.01C. After that, the battery was subjected to constant-current discharge so as to be discharged to 2 V with a current corresponding to 0.05C. The initial discharge capacity (mAh/g) was obtained by dividing the discharge capacity (mAh) by the mass of lithium titanate. The initial efficiency was also obtained by dividing the discharge capacity by the charge capacity. Then, after charging the battery to 0.5 V with a current corresponding to 0.4C, which is the theoretical capacity of lithium titanate, the battery was discharged to 2 V with a current of 0.05C to obtain a 0.4C charge capacity. The charge rate characteristic (%) was calculated by dividing the 0.4C charge capacity by the initial discharge capacity. The initial discharge capacities and charge rate characteristics of Examples 1 to 7 and Examples 1a to 3a were examined as relative values with reference to respective values of Comparative Example 1 being 100%. The results of evaluation are listed in Table 3. The C of 1C represents the current value when charging and discharging. For example, 1C refers to a current value that can fully discharge (or fully charge) the theoretical capacity in 1/1 hour, and 0.1C refers to a current value that can fully discharge (or fully charge) the theoretical capacity in 1/0.1 hour.

TABLE 3

| | | | Example | Example | Example | Example | Example | Example |
|---|---|---|---|---|---|---|---|---|
| | | | 1 | 2 | 3 | 1a | 2a | 3a |
| Lithium | Production | | Production | Production | Production | Production | Production | Production |
| titanate (LTO) | method | | Example | Example | Example | Example | Example | Example |
| | | | 1 | 2 | 3 | 2a | 3a | 4a |
| | Specific surface | | 6.8 | 6.8 | 4.7 | 6.7 | 6.7 | 6.7 |
| | area [m²/g] | | | | | | | |
| | Primary particles | | 0.7 | 0.7 | 0.9 | 0.7 | 0.7 | 0.7 |
| | D50[μm] | | | | | | | |
| | Metal | Type | Al | Al | Al | Mo | W | Ce |
| | elements | | | | | | | |
| | M | Content | 0.13 | 0.28 | 0.13 | 0.51 | 1.00 | 0.89 |
| | | ratio | | | | | | |
| | | [mass %] | | | | | | |
| Solid | Type | | Li₈PS₈Cl | Li₈PS₈Cl | Li₈PS₈Cl | Li₈PS₈Cl | Li₈PS₈Cl | Li₈PS₈Cl |
| electrolyte | | | | | | | | |
| (SE) | | | | | | | | |

| | | | | | | |
|---|---|---|---|---|---|---|
| LTO[mass %]:SE[mass %] | 80:40 | 80:40 | 80:40 | 80:40 | 80:40 | 80:40 |
| Negative electrode active material | 75.5 | 74.3 | 76.7 | 75.6 | 73.4 | 74.5 |
| composition filling rate [%] | | | | | | |
| Negative electrode active material | 104.9 | 103.2 | 106.5 | 105.0 | 101.9 | 103.5 |
| composition relative density ratio [%] | | | | | | |
| Initial discharge capacity [%] | 111.3 | 106.85 | 105.3 | 103.5 | 100.5 | 105.9 |
| Initial efficiency [%] | 89.0 | 84.0 | 90.8 | 82.4 | 76.6 | 83.9 |
| Charge rate characteristics [%] | 153.8 | 120.4 | 182.7 | 216.1 | 218.6 | 232.2 |

| | | | | | | | Comparative |
|---|---|---|---|---|---|---|---|
| | | | Example | Example | Example | Example | Example |
| | | | 4 | 5 | 6 | 7 | 1 |
| Lithium | Production | | Production | Production | Production | Production | Production |
| titanate (LTO) | method | | Example | Example | Example | Example | Example |
| | | | 4 | 5 | 6 | 7 | 8 |
| | Specific surface | | 6.6 | 6.4 | 6.2 | 4.6 | 7.1 |
| | area [m²/g] | | | | | | |
| | Primary particles | | 0.7 | 0.7 | 0.7 | 0.8 | 0.7 |
| | D50[μm] | | | | | | |
| | Metal | Type | Al | Al | Al | Al | — |
| | elements | | Mo | Mo | Mo | Mo | |
| | M | Content | 0.29 | 0.29 | 0.29 | 0.15 | — |
| | | ratio | 0.14 | 0.27 | 0.81 | 0.27 | |
| | | [mass %] | | | | | |
| Solid | Type | | Li₈PS₈Cl | Li₈PS₈Cl | Li₈PS₈Cl | Li₈PS₈Cl | Li₈PS₈Cl |
| electrolyte | | | | | | | |
| (SE) | | | | | | | |

| | | | | | |
|---|---|---|---|---|---|
| LTO[mass %]:SE[mass %] | 80:40 | 80:40 | 80:40 | 80:40 | 80:40 |
| Negative electrode active material | 73.8 | 73.5 | 74.6 | 76.3 | 80:40 |
| composition filling rate [%] | | | | | |
| Negative electrode active material | 102.5 | 102.1 | 103.6 | 106.0 | 100.0 |
| composition relative density ratio [%] | | | | | |
| Initial discharge capacity [%] | 105.3 | 110.0 | 100.2 | 109.8 | 100.0 |
| Initial efficiency [%] | 82.3 | 88.2 | 84.1 | 87.0 | 73.4 |
| Charge rate characteristics [%] | 148.3 | 173.1 | 178.8 | 297.3 | 100.0 |

### Examples 4a to 6a and Comparative Example 1a

All-solid-state secondary batteries were prepared in the same manner as in Example 1 except that the negative electrode active material compositions were used each with the composition ratio of the negative electrode active material composition being a mass ratio of lithium titanate:Li₆PS₅Cl=70:30, and their battery characteristics were evaluated. The results of evaluation are listed in Table 4. The relative density ratios of the pellets of the negative electrode active material compositions, the initial discharge capacities, and the charge rate characteristics according to Examples 4a to 6a are represented as relative values with reference to respective values of Comparative Example 1a being 100%.

TABLE 4

| | | | | | | Comparative |
|---|---|---|---|---|---|---|
| | | | Example | Example | Examg | Example |
| | | | 4a | 5a | 6a | 1a |
| Lithium | Production | | Production | Production | Production | Production |
| titanate (LTO) | method | | Example | Example | Example | Example |
| | | | 1 | 11 | 5a | 8 |
| | Specific surface | | 6.8 | 2.7 | 2.6 | 7.1 |
| | area [m²/g] | | | | | |
| | Primary particles | | 0.7 | 1.7 | 1.6 | 0.7 |
| | D50[μm] | | | | | |
| | Metal | Type | Al | Al | Al | — |
| | elements | | | | Mo | |
| | M | Content | 0.13 | 0.13 | 0.15 | — |
| | | ratio | | | 0.27 | |
| | | [mass %] | | | | |
| Solid | Type | | Li₈PS₈Cl | Li₈PS₈Cl | Li₈PS₈Cl | Li₈PS₈Cl |
| electrolyte | | | | | | |
| (SE) | | | | | | |

| | | | | |
|---|---|---|---|---|
| LTO[mass %]:SE[mass %] | 70:30 | 70:30 | 70:30 | 70:30 |
| Negative electrode active material | 72.4 | 76.8 | 76.9 | 69.4 |
| composition filling rate [%] | | | | |
| Negative electrode active material | 104.3 | 110.7 | 110.8 | 100.0 |
| composition relative density ratio [%] | | | | |
| Initial discharge capacity [%] | 167.5 | 181.6 | 187.7 | 100.0 |
| Initial efficiency [%] | 83.9 | 89.1 | 85.4 | 58.5 |
| Charge rate characteristics [%] | 307.2 | 617.4 | 1086.4 | 100.0 |

### Example 7a and Comparative Example 2a

All-solid-state secondary batteries were prepared in the same manner as in Example 1 except that the negative electrode active material compositions were used each with the composition ratio of the negative electrode active material composition being a mass ratio of lithium titanate:Li₆PS₅Cl=80:20, and their battery characteristics were evaluated. The results of evaluation are listed in Table 5. The relative density ratio of the pellets of the negative electrode active material composition, the initial discharge capacity, and the charge rate characteristics according to Example 7a are represented as relative values with reference to respective values of Comparative Example 2a being 100%.

TABLE 5

| | | | | Comparative |
|---|---|---|---|---|
| | | | Example | Example |
| | | | 7a | 2a |
| Lithium | Production method | | Production | Production |
| titanate (LTO) | | | example 5a | example 8 |
| | Specific surface | | 2.6 | 7.1 |
| | area [m²/g] | | | |
| | Primary particles | | 1.6 | 0.7 |
| | D50(μm) | | | |
| | Metal | Type | Al | — |
| | elements | | Mo | |
| | M | Content | 0.15 | — |
| | | ratio | 0.27 | |
| | | [mass %] | | |
| Solid | Type | | Li₈PS₅Cl | Li₈PS₅Cl |
| electrolyte (SE) | | | | |

| | | |
|---|---|---|
| LTO[mass %]:SE[mass %] | 80:20 | 80:20 |
| Negative electrode active material | 72.7 | 64.0 |
| composition filling rate [%] | | |
| Negative electrode active material | 113.6 | 100.0 |
| composition relative density ratio [%] | | |
| Initial discharge capacity [%] | 472.6 | 100.0 |
| Initial efficiency [%] | 92.7 | 59.7 |
| Charge rate characteristics [%] | 433.2 | 100.0 |

From Tables 3 to 5 above, it can be found that in Examples 1 to 7 and Examples 1a to 7a of the negative electrode active material compositions of the present invention, the relative density ratios are improved compared to Comparative Example 1 and Comparative Examples 1a and 2a and negative electrode active material compositions having fewer voids are formed, and it can also be found that the all-solid-state secondary batteries using the negative electrode active material compositions have excellent initial discharge capacities, initial efficiencies, and charge rate characteristics.

From the above results, the use of the negative electrode active material composition of the present invention can suppress the occurrence of agglomeration of lithium titanate particles, thereby making the negative electrode layer more dense, and the use of the negative electrode layer can form paths of continuous ions and electrons, thus allowing excellent battery characteristics to be exhibited.

1. A negative electrode active material composition comprising:
a lithium titanate powder whose main component is Li₄Ti₅O₁₂; and
an inorganic solid electrolyte having conductivity for metal ions belonging to Group 1 of Periodic Table,
wherein at least one metal element selected from the group consisting of Al, W, Ce, and Mo is present on surfaces of lithium titanate particles constituting the lithium titanate powder.

2. The negative electrode active material composition according to claim 1, wherein the inorganic solid electrolyte is a sulfide solid electrolyte.

3. The negative electrode active material composition according to claim 1, wherein the content ratio of the metal element in the lithium titanate powder is 0.01 mass % or more and 5 mass % or less.

4. The negative electrode active material composition according to claim 1, wherein two or more of the metal elements are present on the surfaces of the lithium titanate powder.

5. The negative electrode active material composition according to claim 1, wherein D50 of primary particles corresponding to a volume accumulation of 50% in a volume-based particle size distribution of the lithium titanate powder is 0.5 μm or more, wherein the volume-based particle size distribution is measured by a laser diffraction scattering method.

6. The negative electrode active material composition according to claim 1, wherein D50 of primary particles corresponding to a volume accumulation of 50% in a volume-based particle size distribution of the lithium titanate powder is 2.5 μm or less, wherein the volume-based particle size distribution is measured by a laser diffraction scattering method.

7. The negative electrode active material composition according to claim 1, wherein the content of the inorganic solid electrolyte is 1 mass % or more and 50 mass % or less in the negative electrode active material composition.

8. The negative electrode active material composition according to claim 1, wherein a relation represented by the following expression (I) is satisfied:
C1>C2 (I)
where C1 (atm %) is a total metal element concentration at an inner position of 1 nm from surfaces of primary particles of the lithium titanate, and C2 (atm %) is the total metal element concentration at a depth position of 100 nm from the surfaces of the primary particles of the lithium titanate.

9. An all-solid-state secondary battery comprising a positive electrode layer, a negative electrode layer, and a solid electrolyte layer, wherein the negative electrode layer is a layer containing the negative electrode active material composition according to claim 1.
